(19) United States
(12) Patent Application Publication
(10) Pub. No.: US 2011/0220722 A1
(43) Pub. Date: Sep. 15, 2011

(54) RFID TAG ANTENNA AND METHOD FOR MAKING SAME

(75) Inventors: TAI-CHERNG YU, Tu-Cheng (TW); YUNG-LUN HUANG, Tu-Cheng (TW)

(73) Assignee: HON HAI PRECISION INDUSTRY CO., LTD., Tu-Cheng (TW)

(21) Appl. No.: 12/781,823

(22) Filed: May 18, 2010

(30) Foreign Application Priority Data
Mar. 12, 2010 (TW) 99107388

(51) Int. Cl. G06K 19/067; B32B 37/14

(52) U.S. Cl. 235/492; 156/163; 977/742

(57) ABSTRACT

An exemplary radio frequency identification tag antenna includes a substrate and a patterned carbon nanotube layer. The patterned carbon nanotube layer is formed on the substrate. The carbon nanotube layer consists of a number of carbon nanotube segments. The carbon nanotube segments are connected end-to-end and well aligned. Each carbon nanotube segment includes a number of carbon nanotubes substantially parallel to each other.

### BACKGROUND

1. Technical Field

The present disclosure relates to radio frequency identification (RFID) tag antennas and methods for making the same.

2. Description of Related Art

Wireless communication has been widely used in various fields. For example, in the logistics management field, a specific usage of wireless communication is with a radio frequency identification (RFID) system. The RFID system typically includes an RFID reader, an RFID tag, and a computer terminal. The RFID tag includes an antenna for receiving and transmitting wireless signals. However, a material of the RFID tag antenna is copper. The copper is easily oxidized over time exposure to the air, which decreases reliability of the RFID system.

Therefore, an RFID tag antenna and a method for making the same, which can overcome the above-mentioned problems, are needed.

### BRIEF DESCRIPTION OF THE DRAWINGS

FIG. 1 is a schematic view of an RFID tag antenna, according to a first exemplary embodiment.

FIG. 2 is a planar view of the RFID tag antenna of FIG. 1.

FIG. 3 is an enlarged schematic view of a carbon nanotube layer used in the RFID tag antenna of FIG. 1.

FIG. 4 is a schematic view of a method for making the carbon nanotube layer of FIG. 3.

### DETAILED DESCRIPTION

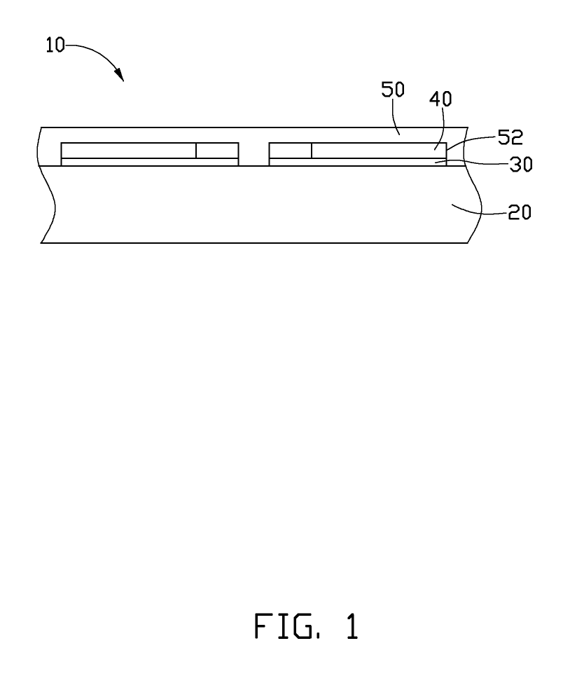

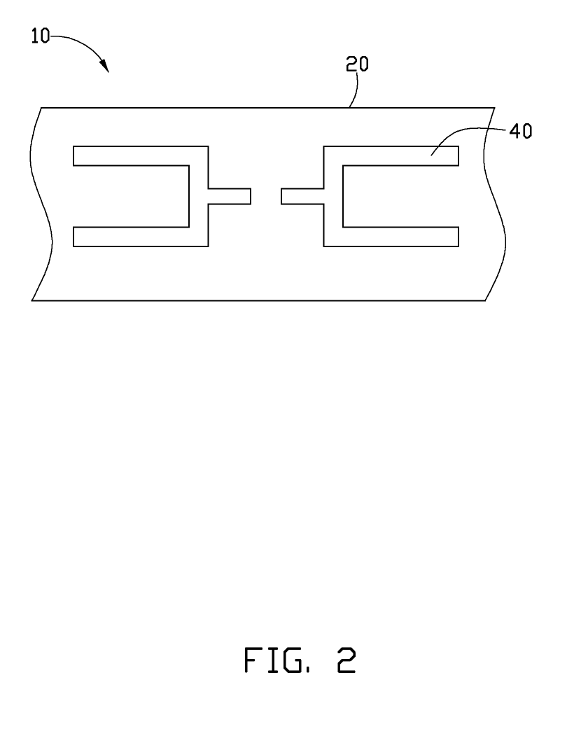

Referring to FIGS. 1 and 2, an RFID tag antenna 10, according to a first exemplary embodiment, includes a substrate 20, an adhesive layer 30, a carbon nanotube (CNT) layer 40, and a protective layer 50.

The adhesive layer 30 is formed on the substrate 20. In this embodiment, the adhesive layer 30 may be formed in a predetermined pattern on the substrate 20. The predetermined pattern may correspond to the design of the antenna. In alternative embodiments, the adhesive layer 30 may be formed on an entire surface of the substrate 20.

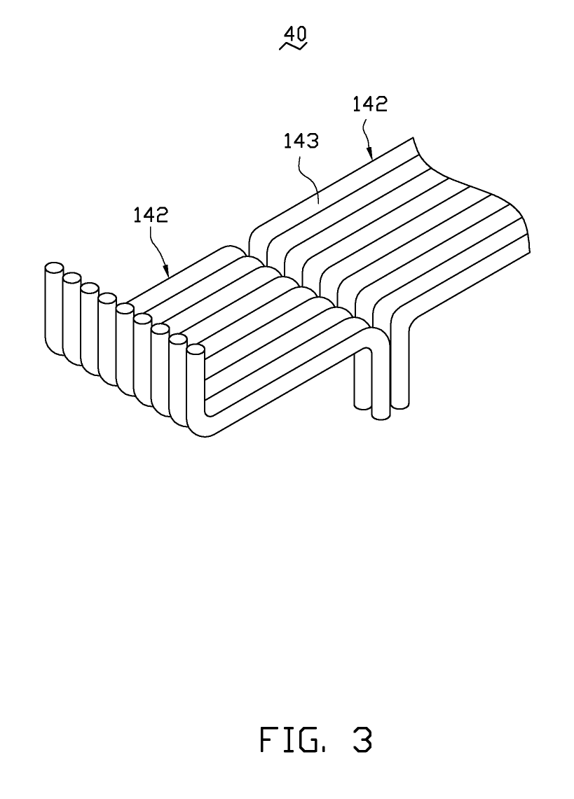

The CNT layer 40 is adhered on the adhesive layer 30 with the predetermined pattern. In this embodiment, referring to FIG. 2, the predetermined pattern is a dipole-antenna pattern. Referring to FIG. 3, the CNT layer 40 consists of a plurality of CNT segments 142 connected end-to-end. The CNT segments 142 are well aligned. Each CNT segment 142 includes a plurality of CNTs 143 substantially parallel to each other. Lengths of the CNT segments 142 are substantially the same. The CNT segments 142 are connected end-to-end due to the van der Waals attractive force between ends of adjacent segments. Aligned directions of the CNTs 143 are substantially parallel to the surface of the substrate 20.

The protective layer 50 covers the CNT layer 40 and the surface of the substrate 20 where the CNT layer 40 is formed to protect from damage caused by handling during assembly and daily usage. The protecting layer 50 is made from an insulating material.

Since the CNT layer 40 is used for material of the antenna 10, the antenna 10 is not easily oxidized, which increases reliability of the RFID system using the RFID tag antenna 10.

A method for making the RFID tag antenna 10, according to a second exemplary embodiment, includes step S100 through step S400. Step S 100: providing a substrate 20, and a CNT film 118 consisting of a plurality of CNT segments 142 connected end-to-end and well aligned. Each CNT segment 142 includes a plurality of CNTs 143 substantially parallel to each other. Step S200: forming an adhesive layer 30 on the substrate 20. Step S300: stretching the CNT film 118 and placing the stretched CNT film 118 on the adhesive layer 30, thereby forming a CNT layer 40 with a predetermined pattern on the substrate 20. Step S400: forming a protective layer 50 to cover the CNT layer 40.

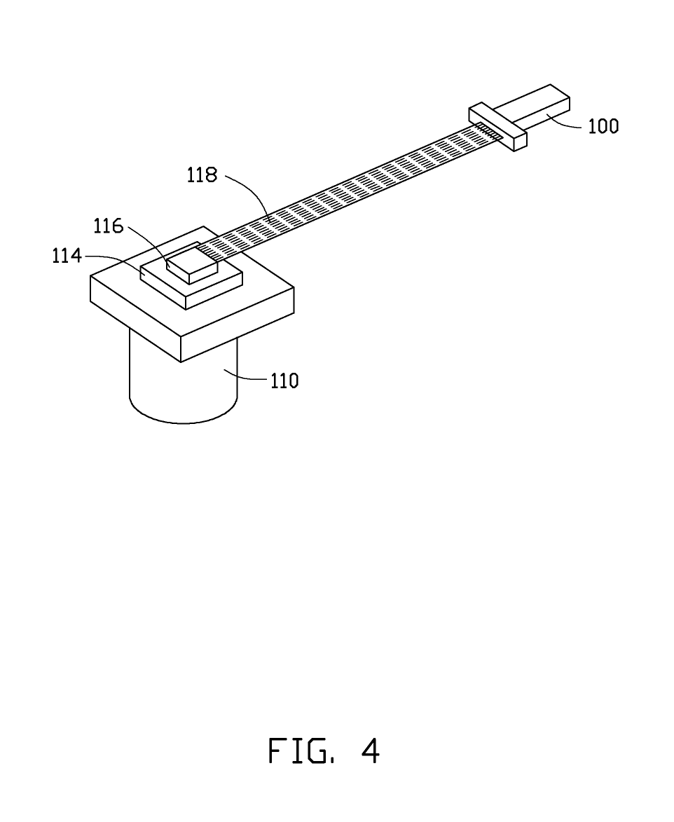

In the step S 100, referring to FIG. 4, the CNT film 118 is made by a pulling method.

The pulling method includes the following steps: (a1) providing a CNT array 116, specifically, a super-aligned CNT array 116, on a substrate 114; and (a2) pulling out the CNT film 118 from the CNT array 116 with a pulling tool 100 (e.g., adhesive tape, pliers, tweezers, or another tool allowing multiple CNTs to be gripped and pulled simultaneously).

In the step (a1), the method for making the super-aligned CNT array 116 on the substrate 114 includes the following sub-steps: (a11) providing a substantially flat and smooth substrate 114; (a12) forming a catalyst layer on the substrate 114; (a13) annealing the substrate 114 with the catalyst layer thereon at a temperature ranging from 700° C. to 900° C. in air for about 30 to 90 minutes; (a14) heating the substrate 114 with the catalyst layer at a temperature ranging from 500° C. to 740° C. in a furnace with a protective gas therein; and (a15) supplying a carbon source gas into the furnace for about 5to 30 minutes, and growing a super-aligned CNT array 116 from the substrate 114.

In the step (a11), the substrate 114 can be a P-type silicon wafer, an N-type silicon wafer, or a silicon wafer with a film of silicon dioxide thereon. A 4-inch P-type silicon wafer is used as the substrate 114 in the present example.

In the step (a12), the catalyst layer can be made of iron (Fe), cobalt (Co), nickel (Ni), or an alloy thereof.

In the step (a14), the protective gas can be made up of at least one of nitrogen (N₂), ammonia (NH₃), and a noble gas. In the step (a15), the carbon source gas can be a hydrocarbon gas, such as ethylene (C₂H₄), methane (CH₄), acetylene (C₂H₂), ethane (C₂H₆), or any combination thereof.

The super-aligned CNT array 116 can be approximately 200 to 400 microns in height and includes a plurality of CNTs parallel to each other and substantially perpendicular to the substrate 114. The super-aligned CNT array 116 formed under the above conditions is essentially free of impurities, such as carbonaceous or residual catalyst particles. The CNTs in the super-aligned CNT array 116 are packed together closely by van der Waals attractive force.

In the present example, the substrate 114 is fixed on a sample platform 110 by an adhesive tape or a binding admixture. Alternatively, the substrate 114 is mechanically fixed on the sample platform 110.

In the step (a2), the CNT film 118 can be formed by the following sub-steps: (a21) selecting a plurality of CNTs having a predetermined width from the super-aligned CNT array 116, binding the CNTs to the pulling tool 100; and (a22) pulling the CNTs at an even/uniform speed to achieve the CNT film 118.

In step (a21), the CNTs having a predetermined width can be selected by using a wide adhesive tape as the tool to contact the super-aligned CNT array 116. In step (a22), the pulling direction is substantially perpendicular to the growing direction of the super-aligned CNT array 116.

During the pulling process, initial CNTs segments 142 are drawn out, other CNT segments 142 are also drawn out end-to-end due to the van der Waals attractive force between ends of adjacent segments. This process of drawing ensures a successive CNT film 118 can be formed. The CNTs 143 of the CNT film 118 are all substantially parallel to the pulling direction and connected end-to-end.

Width of the CNT film 118 depends on the size of the substrate 114. Length of the CNT film 118 is arbitrary and may be determined according to need. In the present example, when the size of the substrate 114 is 4 inches, the width of the CNT film 118 approximately ranges from 1 to 10 centimeters, and the thickness of the CNT film 118 approximately ranges from 0.01 to 100 microns.

If the CNT film 118 is formed having a desirable width, the CNT film 118 may be directly and tightly laid on the adhesive layer 30. If the width of the CNT film 118 is wider than the desirable width, after the CNT film 118 is tightly laid on the adhesive layer 30, laser irradiation may be performed to obtain the desirable width and the predetermined pattern. Furthermore, laser irradiation may also be used to control the thickness of the CNT film 118. The CNTs in the CNT film 118 absorb energy from the laser irradiation and the temperature thereof is increased. The CNT bundles with larger diameters will absorb more energy and be destroyed, and the thickness of the CNT film 118 decreases accordingly.

More specifically, if a thickness of a single CNT film 118 is not satisfactory for a practical use, such as if it is too thin, the CNT layer 40 may then include two or more CNT films 118 stacked together. An angle a between the aligned directions of stacked CNTs 143 in two adjacent CNT films 118 is in a range of 0°≦α≦90°. The CNT films 118 are held together by van der Waals attractive force.

Generally speaking, conductive layers need to be formed uniformly since non-uniform conductive layers may not dissipate heat properly. In this embodiment, the CNT layer 40 made by the pulling method is relatively uniform and a thickness of the CNT layer 40 is generally less than about 100 nanometers, which is an advantage over using copper as a layer with a uniformity the same as that of the CNT layer 40, the thickness of the copper would have to be at least about 200 to 300 nanometers. Therefore, less material is required to achieve a desirable uniformity.

Furthermore, the copper layer is typically formed by a semiconductor manufacturing process. In this process, a copper film may be firstly deposited and then pre-patterned using a photo mask and finally etched to get patterns. This process is more complicated than the pulling method for making the CNT film 118. Therefore, the method for making the RFID tag antenna is simpler than the semiconductor manufacturing process.

In alternative embodiments, the adhesive layer 30 may be omitted. The CNT film 118 is adhesive, because the CNTs have relatively large specific areas, so that the CNT film 118 can be directly attached to the substrate 20 to form the CNT layer 40.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

1. A radio frequency identification tag antenna, comprising:
a substrate; and
a patterned carbon nanotube layer formed on the substrate, the carbon nanotube layer consisting of a plurality of carbon nanotube segments, the carbon nanotube segments being connected end-to-end and well aligned, each carbon nanotube segment comprising a plurality of carbon nanotubes substantially parallel to each other.

2. The radio frequency identification tag antenna of claim 1, wherein aligned directions of the carbon nanotubes are substantially parallel to a surface of the substrate.

3. The radio frequency identification tag antenna of claim 1, further comprising a protecting layer covering the carbon nanotube layer.

4. The radio frequency identification tag antenna of claim 3, wherein the protecting layer is made from an insulating material.

5. The radio frequency identification tag antenna of claim 1, further comprising an adhesive layer sandwiched between the substrate and the carbon nanotube layer.

6. The radio frequency identification tag antenna of claim 1, wherein a thickness of the carbon nanotube layer is less than about 100 nanometers.

7. A method for making a radio frequency identification tag antenna, comprising:
providing a substrate and a carbon nanotube film, the carbon nanotube film consisting of a plurality of carbon nanotube segments, the carbon nanotube segments being connected end-to-end and well aligned, each carbon nanotube segment comprising a plurality of carbon nanotubes substantially parallel to each other; and
stretching the carbon nanotube film and placing the stretched carbon nanotube film on the substrate, and forming a patterned carbon nanotube layer on the substrate using the stretched carbon nanotube film.

8. The method of claim 7, wherein aligned directions of the carbon nanotubes are substantially parallel to a surface of the substrate.

9. The method of claim 7, further comprising: forming an adhesive layer on the substrate before stretching the carbon nanotube film.

10. The method of claim 7, further comprising: forming a protective layer to cover the carbon nanotube layer after the patterned carbon nanotube layer is formed.

11. The method of claim 10, wherein the protecting layer is made from an insulating material.

12. The method of claim 7, wherein the carbon nanotube film is made by pulling out a carbon nanotube film from a super-aligned carbon nanotube array with a pulling tool.

13. The method of claim 7, wherein the carbon nanotube layer is patterned using laser irradiation.

14. The method of claim 7, wherein a thickness of the carbon nanotube layer is less than about 100 nanometers.

15. The radio frequency identification tag antenna of claim 2, wherein the aligned directions of the carbon nanotubes are substantially parallel to a lengthwise direction of the substrate.

16. The radio frequency identification tag antenna of claim 3, wherein the protecting layer defines a plurality of recesses in a bottom thereof, and the carbon nanotube layer is received in the recesses.

17. The radio frequency identification tag antenna of claim 5, wherein the substrate and the carbon nanotube layer are positioned at opposite sides of the adhesive layer.

18. The method of claim 8, wherein the aligned directions of the carbon nanotubes are substantially parallel to a lengthwise direction of the substrate.

19. The method of claim 9, wherein the substrate and the patterned carbon nanotube layer are positioned at opposite sides of the adhesive layer.

20. The method of claim 10, wherein the protecting layer defines a plurality of recesses in a bottom thereof, and the carbon nanotube layer is received in the recesses.
